(19) United States
(12) Patent Application Publication
(10) Pub. No.: US 2025/0256682 A1
(43) Pub. Date: Aug. 14, 2025

(54) AUTHENTICATION MECHANISM FOR VEHICLE MODE OR VEHICLE FUNCTION

(71) Applicant: Atieva, Inc., Newark, CA (US)

(72) Inventors: Ajay Maiti, Fremont, CA (US); Matthew Symonds, Leamington Spa (GB); Gabor Lengyel, Half Moon Bay, CA (US)

(21) Appl. No.: 18/704,846

(22) PCT Filed: Oct. 24, 2022
(86) PCT No.: PCT/US2022/078587

§ 371 Date: Apr. 25, 2024

Related U.S. Application Data
(60) Provisional application No. 63/263,123, filed on Oct. 27, 2021.

(51) Int. Cl. B60R 25/24

(52) U.S. Cl. CPC B60R 25/24

(57) ABSTRACT

A method comprises: receiving, in an offboard computer system separate from a vehicle, a user request for a onetime passcode, the user request including a vehicle identification number (VIN) of the vehicle and a user selection of a function set among multiple functions of the vehicle; generating, by the offboard computer system, a onetime password for the function set based on at least (i) a shared key associated with the function set and the VIN, and (ii) an offboard counter value associated with the function set and the VIN; forming, by the offboard computer system, the onetime passcode from at least the onetime password and a code identifying the function set; and presenting, by the offboard computer system, the onetime passcode in response to the user request.

### CROSS-REFERENCE TO RELATED APPLICATION

This application claims priority to U.S. Patent Application No. 63/263,123, filed on Oct. 27, 2021, and entitled “AUTHENTICATION MECHANISM FOR VEHICLE MODE OR VEHICLE FUNCTION,” the disclosure of which is incorporated by reference herein in its entirety.

### TECHNICAL FIELD

This document relates to an authentication mechanism for a vehicle mode or a vehicle function.

### BACKGROUND

All modern vehicles include a computer system. During ordinary use, the vehicle makes available certain functionalities to the operator. In some circumstances, the vehicle should be placed in an operation mode that may be intended for performing service or diagnostics. In each of such operation modes, one or more ordinary functions can be deactivated, for example.

### SUMMARY

In a first aspect, a method comprises: receiving, in an offboard computer system separate from a vehicle, a user request for a onetime passcode, the user request including a vehicle identification number (VIN) of the vehicle and a user selection of a function set among multiple functions of the vehicle; generating, by the offboard computer system, a onetime password for the function set based on at least (i) a shared key associated with the function set and the VIN, and (ii) an offboard counter value associated with the function set and the VIN; forming, by the offboard computer system, the onetime passcode from at least the onetime password and a code identifying the function set; and presenting, by the offboard computer system, the onetime passcode in response to the user request.

Implementations can include any or all of the following features. Forming the onetime passcode comprises concatenating the onetime password and the code with each other. The onetime password consists of M number of characters, wherein the code consists of N number of characters, and wherein M is greater than N. The method further comprises: receiving, by the offboard computer system, a request for a new shared key for each of the multiple functions of the vehicle; generating, by the offboard computer system, the new shared keys; and providing the new shared keys to the vehicle.

In a second aspect, a method comprises: receiving, in a computer system of a vehicle, a request that includes a onetime passcode, the onetime passcode including (i) a code identifying a function set among multiple functions of the vehicle, and (ii) a first onetime password for the function set; identifying, by the computer system, a shared key stored in the computer system, the shared key identified using the code; generating, by the computer system, a second onetime password based on at least (i) the shared key, and (ii) a vehicle counter value associated with the function set; and in response to the second onetime password matching the first onetime password, marking the request as authenticated.

Implementations can include any or all of the following features. The code and the first onetime password are concatenated with each other in the onetime passcode. Each of the first and second onetime passwords consists of M number of characters, wherein the code consists of N number of characters, and wherein M is greater than N. The function set consists of a single function of the multiple functions. The function set consists of a plurality of functions of the multiple functions. The function set is associated with an operation mode of the vehicle. Activation of the function set corresponds to entering the operation mode, or exiting the operation mode. The method further comprises sending the authenticated request to a vehicle control unit of the vehicle, the vehicle control unit configured for activating or deactivating the function set. The vehicle is presently in a first operation mode when the authenticated request is sent to the vehicle control unit, wherein activation of the function set corresponds to entering a second operation mode of the vehicle, and wherein the vehicle control unit is further configured to reject the authenticated request based on the vehicle presently being in the first operation mode.

### BRIEF DESCRIPTION OF DRAWINGS

FIG. 1 shows an example of a system that provides an authentication mechanism for a vehicle mode or a vehicle function.

FIG. 2 shows an example of an offboard generation of a onetime passcode.

FIG. 3 schematically shows an example of a onetime passcode that can be generated and authenticated by respective aspects of the system of FIG. 1.

FIG. 4 shows an example of an onboard authentication of the onetime passcode of FIG. 3.

FIG. 5 illustrates an example architecture of a computer system.

Like reference symbols in the various drawings indicate like elements.

### DETAILED DESCRIPTION

This document describes examples of systems and techniques for performing authentication with regard to a vehicle mode or a vehicle function. In some implementations, a onetime passcode that is specific to the vehicle mode/function can be generated by an offboard tool, and a service technician (e.g., engineer) can enter the onetime passcode into a human-machine interface of the vehicle. The vehicle can authenticate the onetime passcode in order to allow the vehicle mode/function to be activated or deactivated in the vehicle. Such systems and techniques can improve the security of vehicle operation and can provide useful flexibility for expanding the vehicle's operation modes or otherwise introducing new functions.

Examples described herein refer to a vehicle. As used herein, a vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle. The vehicle can include a passenger compartment accommodating one or more persons. A vehicle can be powered by one or more types of power sources. In some implementations, a vehicle is powered solely by electricity, or can use one or more other energy sources in addition to electricity, to name just a few examples.

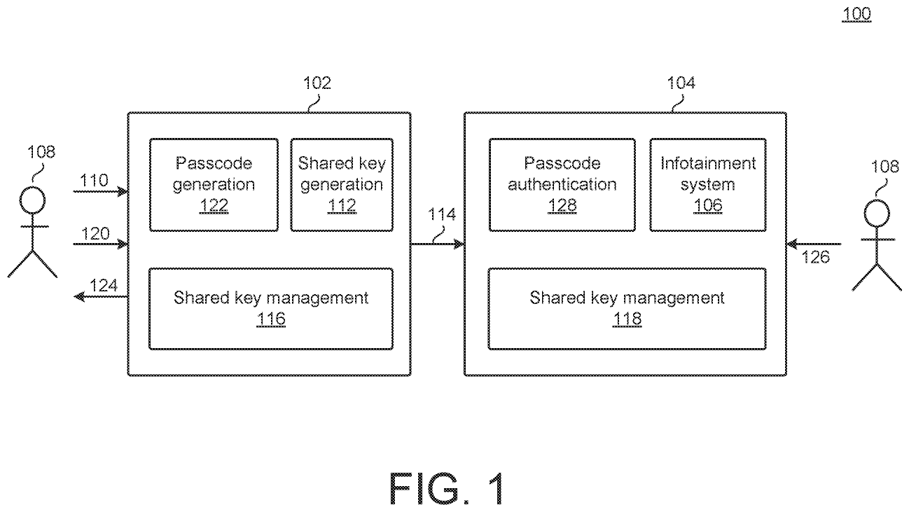

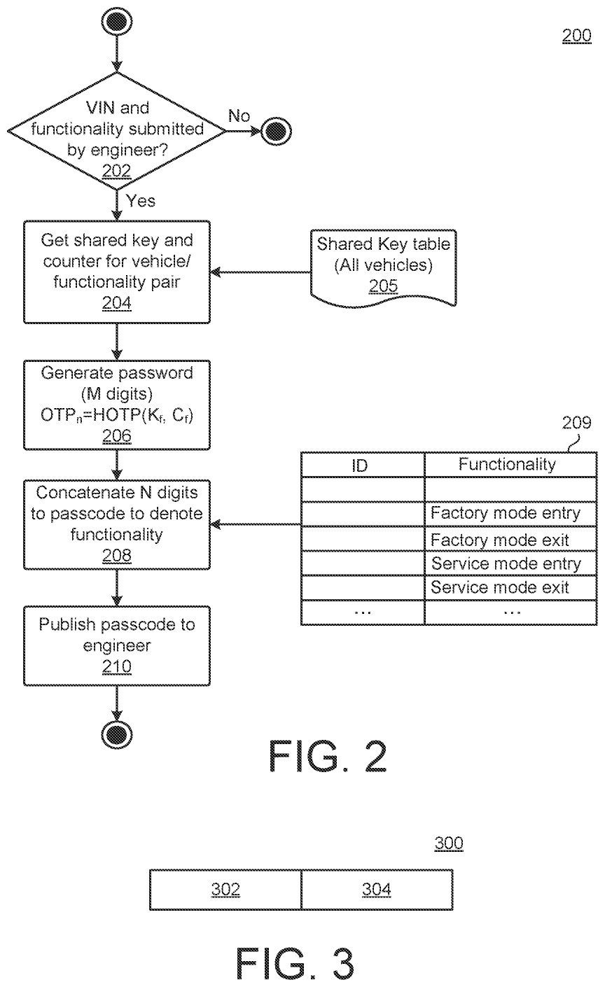

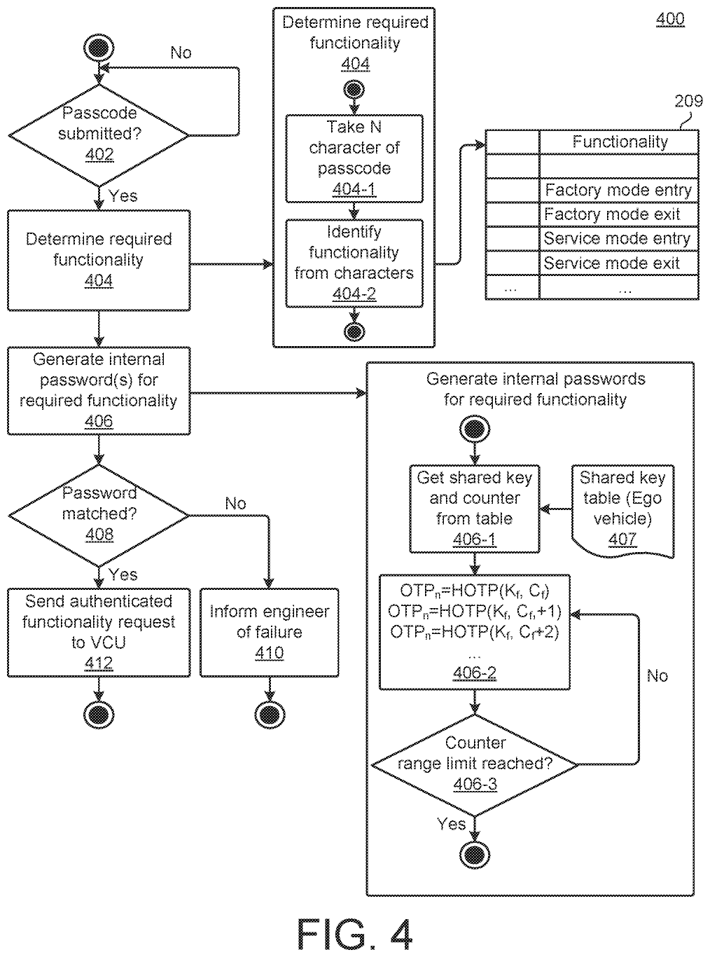

FIG. 1 shows an example of a system 100 that provides an authentication mechanism for a vehicle mode or a vehicle function. FIG. 2 shows an example 200 of an offboard generation of a onetime passcode. FIG. 3 schematically shows an example of a onetime passcode 300 that can be generated and authenticated by respective aspects of the system 100 of FIG. 1. FIG. 4 shows an example 400 of an onboard authentication of the onetime passcode 300 of FIG. 3.

The examples of the present disclosure are presented below with reference to one or more of the drawings. Generally, reference numbers used herein are associated with their respective drawing by way of their first digit. For example, reference numbers 1 are shown in FIG. 1, and so on. An example described herein with reference to any of the drawings can be combined with one or more other examples described elsewhere herein.

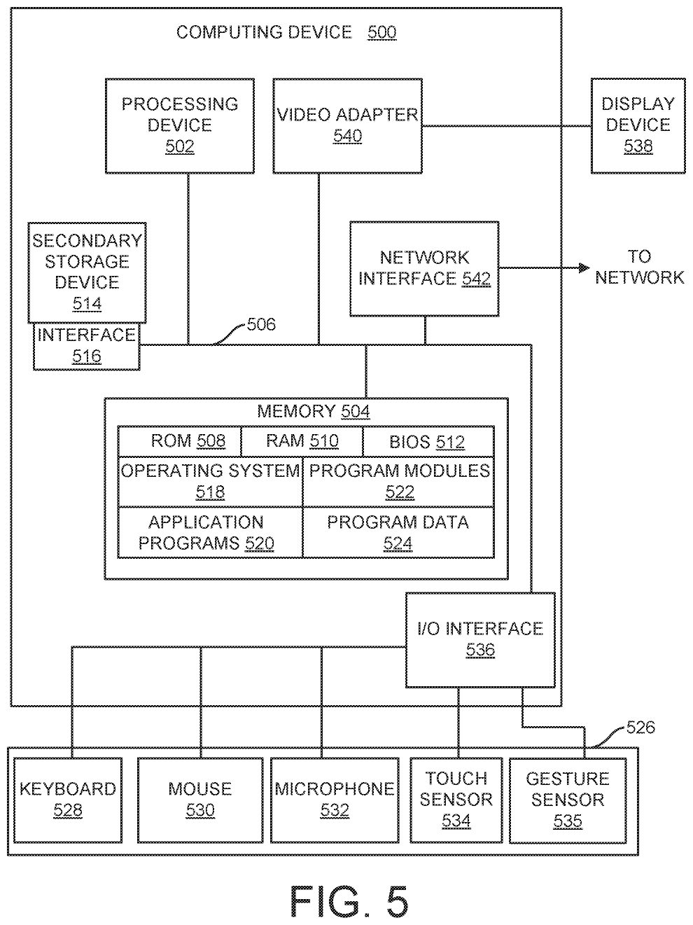

The system 100 includes an offboard computer system 102 and a vehicle 104. The vehicle 104 in part includes a computer system that is configured for controlling and supporting use of the vehicle, including by making multiple functions available. Each of the offboard computer system 102 and the computer system of the vehicle 104 can include some or all of the components described below with reference to FIG. 5.

The offboard computer system 102 is separate from the computer system of the vehicle 104. For example, the offboard computer system 102 can be referred to as an offboard tool that an engineer or a service technician can use for purposes of controlling the vehicle 104 in one or more regards. The computer system of the vehicle 104, by contrast, can be referred to as an onboard system. In some implementations, the offboard computer system 102 includes an offboard server that users can connect to using an authenticated portal. For example, a user can employ a browser or other application on a computer device (e.g., a desktop computer, laptop computer or a portable electronic device) to access and use the functionality of the offboard computer system 102.

Currently, the vehicle 104 may not yet have been configured for authenticating requests regarding vehicle modes/functions. For example, the vehicle 104 can detect that this situation exists upon booting of an infotainment system 106 of the vehicle 104 for the first time in a factory while the vehicle 104 is being manufactured; after a hard reset of the infotainment system 106; or after the infotainment system 106 is replaced in the vehicle 104.

The following example illustrates how the vehicle 104 can be configured for authenticating requests regarding vehicle modes/functions. A user 108 (e.g., a service technician or engineer) can initially trigger an authentication in which the offboard computer system 102 verifies who the user 108 is. For example, this can authenticate the portal that the user 108 is using to access the offboard computer system 102. After such authentication, the user 108 can enter a request 110 into the offboard computer system 102 to generate new shared keys for the vehicle 104. The request 110 for new shared keys includes a vehicle identification number (VIN) of the vehicle 104. Each of such shared keys will be specific to a particular vehicle mode or vehicle function of the vehicle 104. For example, a shared key generation component 112 of the offboard computer system 102 can generate the shared keys.

The offboard computer system 102 can store the shared key using a shared key management component 116. In some implementations, each of the shared keys can be stored in a table where it is associated with a pair of the VIN of the vehicle 104 and an identifier for the vehicle mode or vehicle function. For example, the table can contain any number of rows under the header in Table 1:

TABLE 1

| | | | |
|---|---|---|---|
| VIN | Function | Shared Key | Counter |

The counter value in Table 1 is associated with the particular shared key and is incremented by the offboard computer system 102 each time a onetime password is generated. The vehicle 104 will similarly maintain a counter value for each shared key. If the counter values held by the offboard computer system 102 and the vehicle 104 for any of the shared keys become misaligned within the range of a counter window, the vehicle 104 can nevertheless still perform authentications for that shared key. If the misalignment becomes greater than the counter window, new shared keys can be generated according to the procedure described above.

The shared key generation component 112 can manage shared keys for one or more vehicles. The offboard computer system 102 can provide the vehicle 104, by a communication 114, with the shared keys that are for the vehicle 104. For example, the communication 114 can be performed securely by a virtual private network. The vehicle 104 can store the shared key using a shared key management component 118.

When the vehicle 104 and the offboard computer system 102 are each in possession of the shared keys for the vehicle 104, authentication can be performed by the vehicle 104 to verify the onetime passcode provided by the user 108, before the vehicle 104 allows the user 108 to activate/deactivate a vehicle mode or vehicle function. At the offboard computer system 102, the user 108 enters a request 120 for a onetime passcode. The request 120 can be entered into a passcode generation component 122 of the offboard computer system 102.

At operation 202, it can be determined (e.g., by the passcode generation component 122) whether the request 120 includes at least the VIN of the vehicle 104 and a selection of a function set from among multiple functions of the vehicle 104. As used herein, a function set corresponds to at least one function. For example, the request 120 can identify one function of the vehicle 104. As another example, the request 120 can identify an operation mode of the vehicle 104, such operation mode corresponding to activation and/or deactivation of one or more functions. The user 108 can enter the request 120 by typing characters and/or codes into one or more input fields of the passcode generation component 122, or by selecting one or more predefined choices.

At operation 204, a shared key and its counter value can be obtained. The shared key and the counter value are associated with the VIN and the function set. In some implementations, the passcode generation component 122 can identify, based on the request 120 and using the VIN and the selected function set, at least one of the shared keys of the shared key management component 116 as being associated with the selected function set for the vehicle 104. The shared keys may be securely stored in a table 205 that can constitute, or may be a part of, the shared key management component 116.

At operation 206, a onetime password can be generated. In some implementations, the passcode generation component 122 can generate a onetime password for the selected function set based on the shared key and the counter value for that shared key. The password generation can be defined as

OTPₙ=HOTP(K_{ƒ}, C_{ƒ}),

where OTP represents the onetime password, HOTP is a password-generating function that is hash-based (e.g., a message authentication code generator using a secure hash algorithm), K_{ƒ} is the shared key for the function set ƒ, and C_{ƒ} is the counter value for the shared key. The password-generating function can involve hashing, truncation, and encoding to generate a onetime password. The onetime password can include M number of characters, where M is an integer. For example, the onetime password can include, but is not limited to, digits.

At operation 208, a onetime passcode can be formed from at least the onetime password generated at operation 206 and a code identifying the function set. In some implementations, the passcode generation component 122 concatenates or prepends the onetime password with a code obtained from a table 209. In some implementations, the table 209 can associate respective function sets with codes of a particular format. The code can include N number of characters, where N is an integer. For example, the code can include, but is not limited to, digits. The onetime passcode can then include M+N number of characters. The shared key management component 116 can increment a counter for each generated onetime passcode, the counter associated with the utilized shared key.

The onetime passcode 300, which can be formed at operation 208, can include a portion 302 and a portion 304. The onetime password generated at operation 206 can be included in one of the portions 302 and 304, and the code identifying the function set can be included in the other of the portions 302 and 304. For example, the portion 302 is at the beginning, and the portion 304 at the end, of the onetime passcode 300.

The function sets of the table 209 are shown for illustrative purposes only. In some implementations, one or more function sets can be associated with an operation mode of the vehicle. The shown examples involve “factory mode” and “service mode.” For example, one function set can correspond to entering factory mode, and another function set can correspond to exiting factory mode. As another example, one function set can correspond to entering service mode, and another function set can correspond to exiting service mode. Other approaches can be used, for example by extending the table 209.

In some implementations, a function set selected by the user 108 can consist of a plurality of the multiple functions of the vehicle. For example, the function set can represent a grouping of a plurality of functions together for activation and/or deactivation, subject to authentication of the onetime passcode. In some implementations, a function set selected by the user 108 can consist of a single function of the multiple functions of the vehicle.

At operation 210, the onetime passcode can be presented. In some implementations, the passcode generation component 122 makes a presentation 124 of the onetime passcode at the offboard computer system 102 (e.g., on a display device).

The above examples illustrate that a method can include receiving (e.g., in the offboard computer system 102) a user request (e.g., the request 120) for a onetime passcode. The user request includes a VIN of the vehicle and a user selection of a function set among multiple functions of the vehicle (e.g., any of the function sets in the table 209). The method includes generating, by the offboard computer system, a onetime password for the function set (e.g., at operation 206). The onetime password is based on at least (i) a shared key (e.g., from Table 1 above) associated with the function set and the VIN, and (ii) an offboard counter value (e.g., from Table 1 above) associated with the function set and the VIN. The method includes forming the onetime passcode by the offboard computer system (e.g., at operation 208). The onetime passcode is formed from at least the onetime password and a code identifying the function set (e.g., in table 209). The method includes presenting, by the offboard computer system, the onetime passcode in response to the user request (e.g., at operation 210).

After the onetime passcode has been presented by the offboard computer system 102, the onetime passcode can be entered into the infotainment system 106 of the vehicle 104. In this example, it is the user 108 who enters a request 126 with the onetime passcode. The onetime passcode identifies a function set among the multiple functions of the vehicle 104 and includes a onetime password for the function set. At operation 402, it can be determined that the onetime passcode has been received.

At operation 404, it can be determined what function set has been identified by the request. The determination can be performed by a passcode authentication component 128 of the vehicle 104. In some implementations, an operation 404-1 includes obtaining N number of characters from the onetime passcode (e.g., either of the portions 302 or 304 of the onetime passcode 300). From the N number of characters, the function set can be identified at an operation 404-2. For example, the table 209 can include pairings of codes with respective function sets. If the code obtained from the onetime passcode does not match any of the codes in the table 209, the vehicle can present an error message to the user 108 and can cease further operations regarding the request 126.

At operation 406, one or more onetime passwords for the function set can be generated by the passcode authentication component 128. An operation 406-1 involves obtaining a shared key and its associated counter value that are stored in the vehicle's computer system. In some implementations, the shared key management component 118 can include a table 407 that is securely stored. For example, a table for shared keys and counter values can contain any number of rows under the header in Table 2:

TABLE 2

| | | |
|---|---|---|
| Function | Shared Key | Counter |

At operation 406-2, the vehicle can generate one or more onetime passwords for checking the onetime password included in the onetime passcode of the request 126. A first attempt within the operation 406-2 can involve using the vehicle's present counter value for the identified function set, as indicated by the expression OTPₙ=HOTP(K_{ƒ}, C_{ƒ}). If the onetime password obtained using that counter value (C_{ƒ}) does not match the onetime password of the request 126, the passcode authentication component 128 can increment the counter value one or more times, as indicated by the expressions OTPₙ=HOTP(K_{ƒ}, C_{ƒ}+1) and so on in the operation 406-2.

An operation 406-3 will terminate the operation 406-2 when a limit of the range of counter value increments has been reached. For example, this limit can be referred to as a counter window that allows the vehicle 104 to make a number of attempts in attempting to authenticate the onetime passcode of the request 126, in case respective counters have become misaligned. An outcome of an operation 408 can then reflect that no matching onetime password was generated. In an operation 410, the user 108 can be informed of the failure to authenticate the request 126. The user 108 can then trigger the shared key generation component 112 to generate a new set of shared keys for the vehicle 104.

If the onetime password generated at any of the iterations in the operation 406-2 is a match, the operation 406-2 can be terminated. An outcome of the operation 408 can then reflect that a matching onetime password was generated. The shared key management component 118 can reset the counter based on the counter value increment that was successful, and increment the counter by one. Similarly, the offboard computer system 102 incremented its counter by one after generating the code. The request 126 can be marked, such as by the passcode authentication component 128, as being authenticated.

Thereafter, an operation 412 can be performed to send the authenticated request to a vehicle control unit (VCU) of the vehicle 104. The VCU is configured for activating or deactivating the function set according to the sent request. For example, the vehicle can be entered into, or exited from, any of its operating modes.

The VCU can reject the request 126 under one or more circumstances. In some implementations, certain activations and/or deactivations of vehicle functions are not permitted while one or more other functions are active or deactivated. For example, assume that the vehicle 104 is presently in factory mode when the request 126 is received, and that the request 126 corresponds to entering the vehicle 104 into service mode. The VCU may be configured to not allow a state change from a first operation mode (e.g., the factory mode) into a second operation mode (e.g., the service mode) without an intervening exit from the first operation mode. Thus, when the VCU receives the request 126 calling for entering into service mode while the vehicle 104 is in factory mode, the VCU can reject the request 126.

The above examples illustrate that a method can include receiving a request (e.g., the request 126) in a computer system of a vehicle (e.g., in the passcode authentication component 128, as facilitated by the infotainment system 106). The request includes a onetime passcode including (i) a code identifying a function set among multiple functions of the vehicle (e.g., from the table 209), and (ii) a first onetime password for the function set (e.g., generated at the operation 206). The method includes identifying a shared key stored in the computer system (e.g., in the table 407). The shared key is identified by the computer system using the code (e.g., as obtained in the operation 404-1). The method includes generating, by the computer system, a second onetime password (e.g., by the operation 406). The second onetime password is generated based on at least the shared key (e.g., obtained from the table 407), and a vehicle counter value (e.g., obtained from the table 407) associated with the function set. In response to the second onetime password matching the first onetime password, the method can include marking the request as authenticated.

FIG. 5 illustrates an example architecture of a computing device 500 that can be used to implement aspects of the present disclosure, including any of the systems, apparatuses, and/or techniques described herein, or any other systems, apparatuses, and/or techniques that may be utilized in the various possible embodiments.

The computing device illustrated in FIG. 5 can be used to execute the operating system, application programs, and/or software modules (including the software engines) described herein.

The computing device 500 includes, in some embodiments, at least one processing device 502 (e.g., a processor), such as a central processing unit (CPU). A variety of processing devices are available from a variety of manufacturers, for example, Intel or Advanced Micro Devices. In this example, the computing device 500 also includes a system memory 504, and a system bus 506 that couples various system components including the system memory 504 to the processing device 502. The system bus 506 is one of any number of types of bus structures that can be used, including, but not limited to, a memory bus, or memory controller; a peripheral bus; and a local bus using any of a variety of bus architectures.

Examples of computing devices that can be implemented using the computing device 500 include a desktop computer, a laptop computer, a tablet computer, a mobile computing device (such as a smart phone, a touchpad mobile digital device, or other mobile devices), or other devices configured to process digital instructions.

The system memory 504 includes read only memory 508 and random access memory 510. A basic input/output system 512 containing the basic routines that act to transfer information within computing device 500, such as during start up, can be stored in the read only memory 508.

The computing device 500 also includes a secondary storage device 514 in some embodiments, such as a hard disk drive, for storing digital data. The secondary storage device 514 is connected to the system bus 506 by a secondary storage interface 516. The secondary storage device 514 and its associated computer readable media provide nonvolatile and non-transitory storage of computer readable instructions (including application programs and program modules), data structures, and other data for the computing device 500.

Although the example environment described herein employs a hard disk drive as a secondary storage device, other types of computer readable storage media are used in other embodiments. Examples of these other types of computer readable storage media include magnetic cassettes, flash memory cards, solid-state drives (SSD), digital video disks, Bernoulli cartridges, compact disc read only memories, digital versatile disk read only memories, random access memories, or read only memories. Some embodiments include non-transitory media. For example, a computer program product can be tangibly embodied in a non-transitory storage medium. Additionally, such computer readable storage media can include local storage or cloud-based storage.

A number of program modules can be stored in secondary storage device 514 and/or system memory 504, including an operating system 518, one or more application programs 520, other program modules 522 (such as the software engines described herein), and program data 524. The computing device 500 can utilize any suitable operating system.

In some embodiments, a user provides inputs to the computing device 500 through one or more input devices 526. Examples of input devices 526 include a keyboard 528, mouse 530, microphone 532 (e.g., for voice and/or other audio input), touch sensor 534 (such as a touchpad or touch sensitive display), and gesture sensor 535 (e.g., for gestural input). In some implementations, the input device(s) 526 provide detection based on presence, proximity, and/or motion. Other embodiments include other input devices 526. The input devices can be connected to the processing device 502 through an input/output interface 536 that is coupled to the system bus 506. These input devices 526 can be connected by any number of input/output interfaces, such as a parallel port, serial port, game port, or a universal serial bus. Wireless communication between input devices 526 and the input/output interface 536 is possible as well, and includes infrared, BLUETOOTH® wireless technology, 802.11a/b/g/n, cellular, ultra-wideband (UWB), ZigBee, or other radio frequency communication systems in some possible embodiments, to name just a few examples.

In this example embodiment, a display device 538, such as a monitor, liquid crystal display device, light-emitting diode display device, projector, or touch sensitive display device, is also connected to the system bus 506 via an interface, such as a video adapter 540. In addition to the display device 538, the computing device 500 can include various other peripheral devices (not shown), such as speakers or a printer.

The computing device 500 can be connected to one or more networks through a network interface 542. The network interface 542 can provide for wired and/or wireless communication. In some implementations, the network interface 542 can include one or more antennas for transmitting and/or receiving wireless signals. When used in a local area networking environment or a wide area networking environment (such as the Internet), the network interface 542 can include an Ethernet interface. Other possible embodiments use other communication devices. For example, some embodiments of the computing device 500 include a modem for communicating across the network.

The computing device 500 can include at least some form of computer readable media. Computer readable media includes any available media that can be accessed by the computing device 500. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 500.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 5 is also an example of programmable electronics, which may include one or more such computing devices, and when multiple computing devices are included, such computing devices can be coupled together with a suitable data communication network so as to collectively perform the various functions, methods, or operations disclosed herein.

In some implementations, the computing device 500 can be characterized as an ADAS computer. For example, the computing device 500 can include one or more components sometimes used for processing tasks that occur in the field of artificial intelligence (AI). The computing device 500 then includes sufficient proceeding power and necessary support architecture for the demands of ADAS or AI in general. For example, the processing device 502 can include a multicore architecture. As another example, the computing device 500 can include one or more co-processors in addition to, or as part of, the processing device 502. In some implementations, at least one hardware accelerator can be coupled to the system bus 506. For example, a graphics processing unit can be used. In some implementations, the computing device 500 can implement a neural network-specific hardware to handle one or more ADAS tasks.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A method comprising:
receiving, in an offboard computer system separate from a vehicle, a user request for a onetime passcode, the user request including a vehicle identification number (VIN) of the vehicle and a user selection of a function set among multiple functions of the vehicle;
generating, by the offboard computer system, a onetime password for the function set based on at least (i) a shared key associated with the function set and the VIN, and (ii) an offboard counter value associated with the function set and the VIN;
forming, by the offboard computer system, the onetime passcode from at least the onetime password and a code identifying the function set; and
presenting, by the offboard computer system, the onetime passcode in response to the user request.

2. The method of claim 1, wherein forming the onetime passcode comprises concatenating the onetime password and the code with each other.

3. The method of claim 1, wherein the onetime password consists of M number of characters, wherein the code consists of N number of characters, and wherein M is greater than N.

4. The method of claim 1, further comprising:
receiving, by the offboard computer system, a request for a new shared key for each of the multiple functions of the vehicle;
generating, by the offboard computer system, the new shared keys; and
providing the new shared keys to the vehicle.

5. A method comprising:
receiving, in a computer system of a vehicle, a request that includes a onetime passcode, the onetime passcode including (i) a code identifying a function set among multiple functions of the vehicle, and (ii) a first onetime password for the function set;
identifying, by the computer system, a shared key stored in the computer system, the shared key identified using the code;
generating, by the computer system, a second onetime password based on at least (i) the shared key, and (ii) a vehicle counter value associated with the function set; and
in response to the second onetime password matching the first onetime password, marking the request as authenticated.

6. The method of claim 5, wherein the code and the first onetime password are concatenated with each other in the onetime passcode.

7. The method of claim 5, wherein each of the first and second onetime passwords consists of M number of characters, wherein the code consists of N number of characters, and wherein M is greater than N.

8. The method of claim 5, wherein the function set consists of a single function of the multiple functions.

9. The method of claim 5, wherein the function set consists of a plurality of functions of the multiple functions.

10. The method of claim 5, wherein the function set is associated with an operation mode of the vehicle.

11. The method of claim 10, wherein activation of the function set corresponds to entering the operation mode, or exiting the operation mode.

12. The method of claim 5, further comprising sending the authenticated request to a vehicle control unit of the vehicle, the vehicle control unit configured for activating or deactivating the function set.

13. The method of claim 12, wherein the vehicle is presently in a first operation mode when the authenticated request is sent to the vehicle control unit, wherein activation of the function set corresponds to entering a second operation mode of the vehicle, and wherein the vehicle control unit is further configured to reject the authenticated request based on the vehicle presently being in the first operation mode.

14. A system configured to perform the method of claim 1.

15. A system configured to perform the method of any of claim 5.
